(19) United States
(12) Patent Application Publication
(10) Pub. No.: US 2025/0150933 A1
(43) Pub. Date: May 8, 2025

(54) GROUPCAST OR BROADCAST USER EQUIPMENT TO USER EQUIPMENT RELAYING

(71) Applicant: QUALCOMM Incorporated, San Diego, CA (US)

(72) Inventors: Karthika PALADUGU, Hyderabad (IN); Gavin Bernard HORN, La Jolla, CA (US); Hong CHENG, Basking Ridge, NJ (US); Peng CHENG, Beijing (CN)

(21) Appl. No.: 18/838,948

(22) PCT Filed: Apr. 12, 2022
(86) PCT No.: PCT/CN2022/086312

§ 371 Date: Aug. 15, 2024

(51) Int. Cl. H04W 40/22; H04W 4/06; H04W 88/04

(52) U.S. Cl. CPC H04W 40/22; H04W 4/06; H04W 88/04

(57) ABSTRACT

Various aspects of the present disclosure generally relate to wireless communication. In some aspects. a source node may discover one or more relay nodes. The source node may select a multi-node communication mode. from a relaying multi-node communication mode and a non-relaying multi-node communication mode. for a transmission. The source node may transmit. to the one or more relay nodes. an indication of a relaying configuration associated with the selected groupcast mode. The source node may transmit the transmission to the one or more relay nodes based at least in part on the selected groupcast mode or the relaying configuration. Numerous other aspects are described.

### FIELD OF THE DISCLOSURE

Aspects of the present disclosure generally relate to wireless communication and to techniques and apparatuses for groupcast or broadcast user equipment to user equipment relaying.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIGS. 5A and 5B are diagram illustrating examples of a first discovery model and a second discovery model for UEs performing sidelink communications, in accordance with the present disclosure.

FIG. 6 is a diagram illustrating an example of a user plane protocol stack for Layer 2 UE-to-UE relaying and an example of a user plane protocol stack for Layer 3 UE-to-UE relaying, in accordance with the present disclosure.

FIG. 7 is a diagram illustrating examples of UE-to-UE relaying modes, in accordance with the present disclosure.

FIG. 8 is a diagram illustrating examples of simple groupcast relaying and selective groupcast relaying, in accordance with the present disclosure.

FIG. 9 is a diagram illustrating an example of groupcast relaying, in accordance with the present disclosure.

FIGS. 10-11 are diagrams illustrating example processes for wireless communication, in accordance with the present disclosure.

FIGS. 12-13 are diagrams of example apparatuses for wireless communication, in accordance with the present disclosure.

### SUMMARY

Some aspects described herein relate to a method of wireless communication performed by a source node. The method may include discovering one or more relay nodes. The method may include transmitting a relaying configuration or an indication associated with the relaying configuration, wherein the relaying configuration is associated with a selected multi-node communication mode including at least one of a relaying multi-node communication mode or a non-relaying multi-node communication mode. The method may include transmitting a transmission to the one or more relay nodes based at least in part on the selected multi-node communication mode.

Some aspects described herein relate to a method of wireless communication performed by a relay node. The method may include discovering a source node and one or more destination nodes. The method may include receiving a relaying configuration or an indication associated with the relaying configuration associated with a relaying multi-node communication mode. The method may include receiving a transmission from the source node. The method may include relaying the transmission to the one or more destination nodes based at least in part on the relaying configuration.

Some aspects described herein relate to a source node for wireless communication. The source node may include a memory and one or more processors coupled to the memory. The one or more processors may be configured to discover one or more relay nodes. The one or more processors may be configured to transmit a relaying configuration or an indication associated with the relaying configuration, wherein the relaying configuration is associated with a selected multi-node communication mode including at least one of a relaying multi-node communication mode or a non-relaying multi-node communication mode. The one or more processors may be configured to transmit a transmission to the one or more relay nodes based at least in part on the selected multi-node communication mode or the relaying configuration.

Some aspects described herein relate to a relay node for wireless communication. The relay node may include a memory and one or more processors coupled to the memory. The one or more processors may be configured to discover a source node and one or more destination nodes. The one or more processors may be configured to receive a relaying configuration or an indication associated with the relaying configuration associated with a relaying multi-node communication mode. The one or more processors may be configured to receive a transmission from the source node. The one or more processors may be configured to relay the transmission to the one or more destination nodes based at least in part on the relaying configuration.

Some aspects described herein relate to a non-transitory computer-readable medium that stores a set of instructions for wireless communication by a source node. The set of instructions, when executed by one or more processors of the source node, may cause the source node to discover one or more relay nodes. The set of instructions, when executed by one or more processors of the source node, may cause the source node to transmit a relaying configuration or an indication associated with the relaying configuration, wherein the relaying configuration is associated with a selected multi-node communication mode including at least one of a relaying multi-node communication mode or a non-relaying multi-node communication mode. The set of instructions, when executed by one or more processors of the source node, may cause the source node to transmit a transmission to the one or more relay nodes based at least in part on the selected multi-node communication mode.

Some aspects described herein relate to a non-transitory computer-readable medium that stores a set of instructions for wireless communication by a relay node. The set of instructions, when executed by one or more processors of the relay node, may cause the relay node to discover a source node and one or more destination nodes. The set of instructions, when executed by one or more processors of the relay node, may cause the relay node to receive a relaying configuration or an indication associated with the relaying configuration associated with a relaying multi-node communication mode. The set of instructions, when executed by one or more processors of the relay node, may cause the relay node to receive a transmission from the source node. The set of instructions, when executed by one or more processors of the relay node, may cause the relay node to relay the transmission to the one or more destination nodes based at least in part on the relaying configuration.

Some aspects described herein relate to an apparatus for wireless communication. The apparatus may include means for discovering one or more relay nodes. The apparatus may include means for transmitting a relaying configuration or an indication associated with the relaying configuration, wherein the relaying configuration is associated with a selected multi-node communication mode including at least one of a relaying multi-node communication mode or a non-relaying multi-node communication mode. The apparatus may include means for transmitting a transmission to the one or more relay nodes based at least in part on the selected multi-node communication mode.

Some aspects described herein relate to an apparatus for wireless communication. The apparatus may include means for discovering a source node and one or more destination nodes. The apparatus may include means for receiving a relaying configuration or an indication associated with the relaying configuration associated with a relaying multi-node communication mode. The apparatus may include means for receiving a transmission from the source node. The apparatus may include means for relaying the transmission to the one or more destination nodes based at least in part on the relaying configuration.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

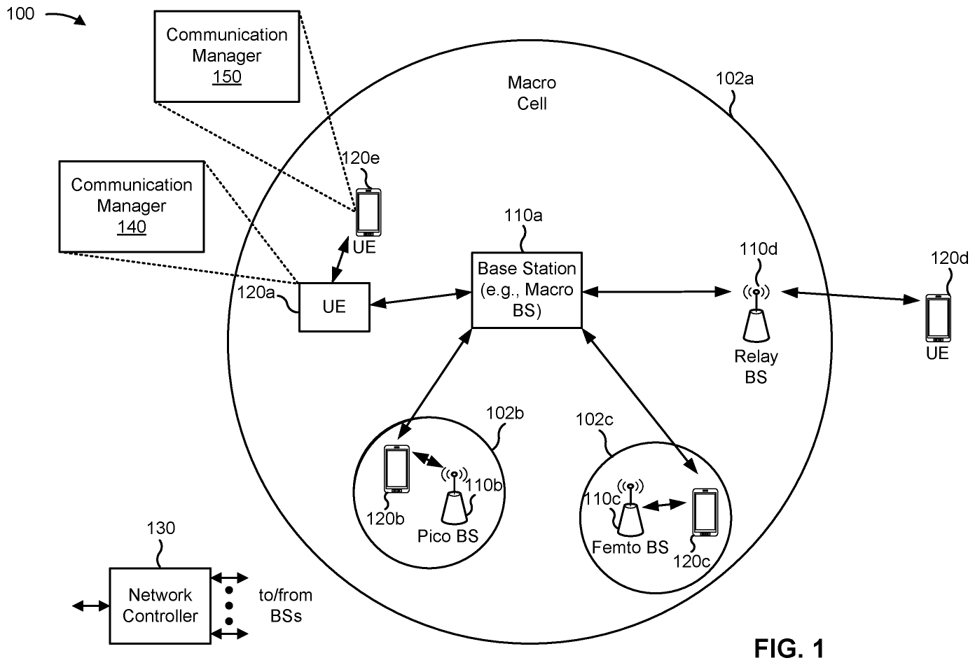

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a source node (such as UE 120) may include a communication manager 140. As described in more detail elsewhere herein, the communication manager 140 may discover one or more relay nodes; transmit, to the one or more relay nodes, an indication of a relaying configuration associated with a selected multi-node communication mode, of a relaying multi-node communication mode and a non-relaying multi-node communication mode; and transmit a transmission to the one or more relay nodes based at least in part on the selected multi-node communication mode or the relaying configuration. Additionally, or alternatively, the communication manager 140 may perform one or more other operations described herein.

In some aspects, a relay node (such as UE 120) may include a communication manager 150. As described in more detail elsewhere herein, the communication manager 150 may discover a source node and one or more destination nodes; receive an indication of a relaying configuration associated with a relaying multi-node communication mode; receive a transmission from the source node; and relay the transmission to the one or more destination nodes based at least in part on the relaying configuration. Additionally, or alternatively, the communication manager 150 may perform one or more other operations described herein.

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some aspects, the term “base station” (e.g., the base station 110) or “network node” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a CU, a DU, an RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

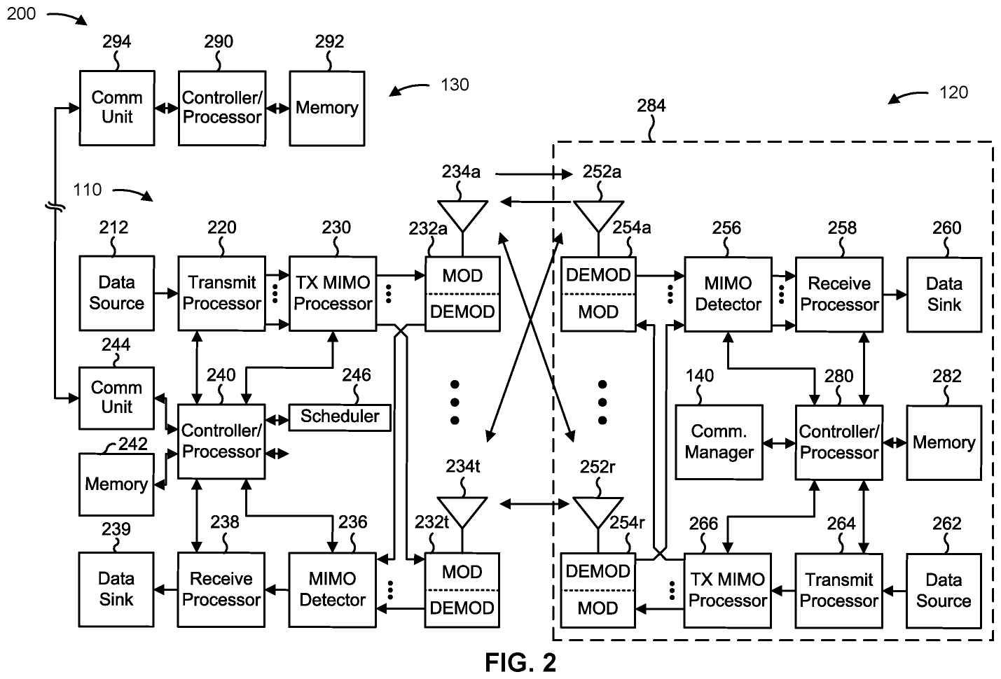

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

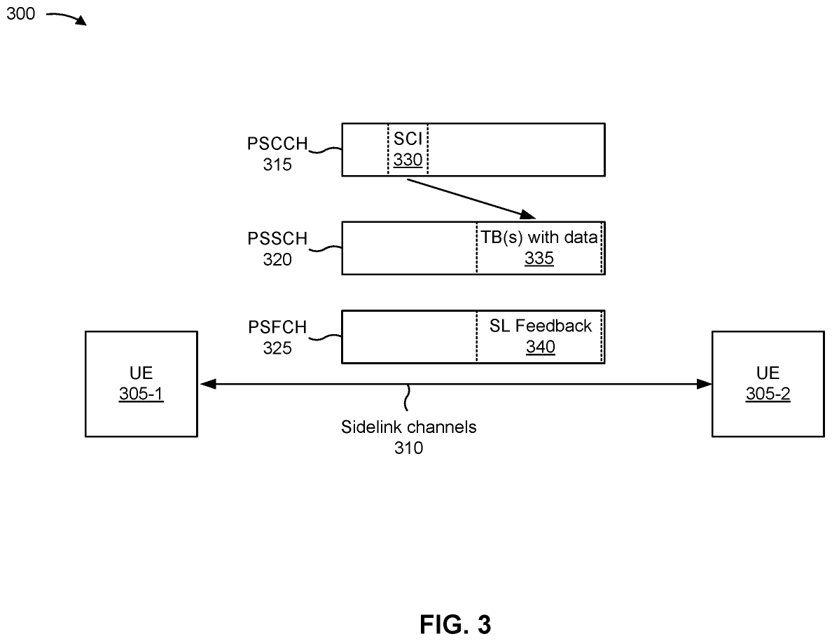

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-13).

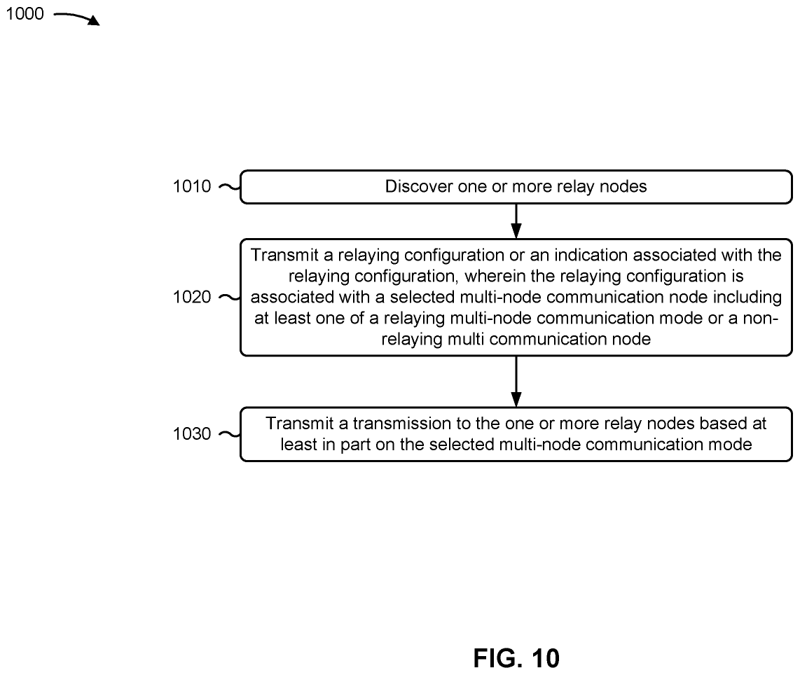

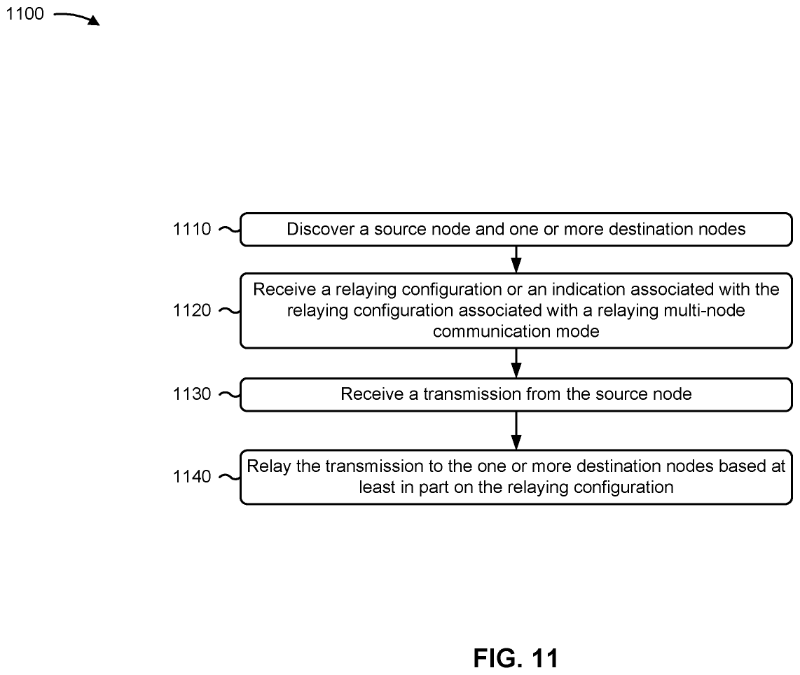

The controller/processor 240 of the base station 110, the controller/processor 280 of the UE 120, and/or any other component(s) of FIG. 2 may perform one or more techniques associated with groupcast relaying, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a source node (such as UE 120) includes means for discovering one or more relay nodes; means for transmitting, to the one or more relay nodes, an indication of a relaying configuration associated with a selected multi-node communication mode, of a relaying multi-node communication mode and a non-relaying multi-node communication mode; and/or means for transmitting a transmission to the one or more relay nodes based at least in part on the selected multi-node communication mode or the relaying configuration. In some aspects, the means for the source node to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a relay node (such as UE 120) includes means for discovering a source node and one or more destination nodes; means for receiving an indication of a relaying configuration associated with a relaying multi-node communication mode; means for receiving a transmission from the source node; and/or means for relaying the transmission to the one or more destination nodes based at least in part on the relaying configuration. In some aspects, the means for the relay node to perform operations described herein may include, for example, one or more of communication manager 150, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Nodes, such as UEs or devices, may communicate with one another via local links, such as sidelink connections. In some cases, it may be beneficial for a node (referred to herein as a relay UE) to relay a communication from a source node (e.g., a source UE) to a destination node (e.g., a destination UE). For example, since UEs are associated with lower transmit power, relaying may improve coverage and function of a device-to-device network. Examples of UE-to-UE relaying techniques include Layer 2 relaying, where routing of relayed traffic is handled by an adaptation layer (Layer 2) of a relay node, and Layer 3 relaying, where routing of relayed traffic is handled by an IP layer of a relay node.

Traditional UE-to-UE relaying may be unicast, meaning that a unicast link is established on each hop of a relay (e.g., one unicast link between a source node and a relay node, and another unicast link between a relay node and a destination node). Further, there may be a virtual end-to-end unicast link (such as a PC5-S connection and PC5-RRC connection between devices) between the source node and the destination node. However, the establishment and maintenance of such links may involve considerable overhead. Furthermore, many device-to-device communications are groupcast communications (which, as used herein, can refer to groupcast transmissions that involve feedback as well as broadcast transmissions for which no feedback is provided). It may be infeasible to establish unicast links (both unicast links on each hop of a relay, and virtual end-to-end unicast links) for each pair of source node and destination node associated with a groupcast transmission. Furthermore, the inability to meaningfully facilitate groupcast relaying may mean that groupcast transmissions are associated with suboptimal coverage and reliability relative to communications that can be relayed.

Techniques described herein provide groupcast and broadcast relaying, sometimes referred to herein as multi-node relaying. For example, a relay node may receive a transmission (e.g., a groupcast or broadcast transmission) and may relay the transmission using groupcast or broadcast signaling to a group of destination nodes. The relay node may relay the transmission without establishing unicast links with the source node or the group of destination nodes. Furthermore, in some examples, the source node may not be associated with an end-to-end unicast link with the group of destination nodes. In some aspects, multiple relay nodes may each relay a transmission to respective groups of destination nodes. In some aspects, particular relay nodes may be selected to relay a transmission (either by the source node or by the relay nodes themselves). In this way, groupcast and broadcast relaying for device-to-device communication is enabled. Thus, overhead associated with link establishment is reduced, and coverage and reliability of groupcast and broadcast transmissions is improved.

FIG. 3 is a diagram illustrating an example 300 of sidelink communications, in accordance with the present disclosure. The description of example 300 provides UEs as examples of nodes which may perform the operations of example 300. However, example 300 can be implemented using another type of node, such as a wireless communication device other than a UE.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

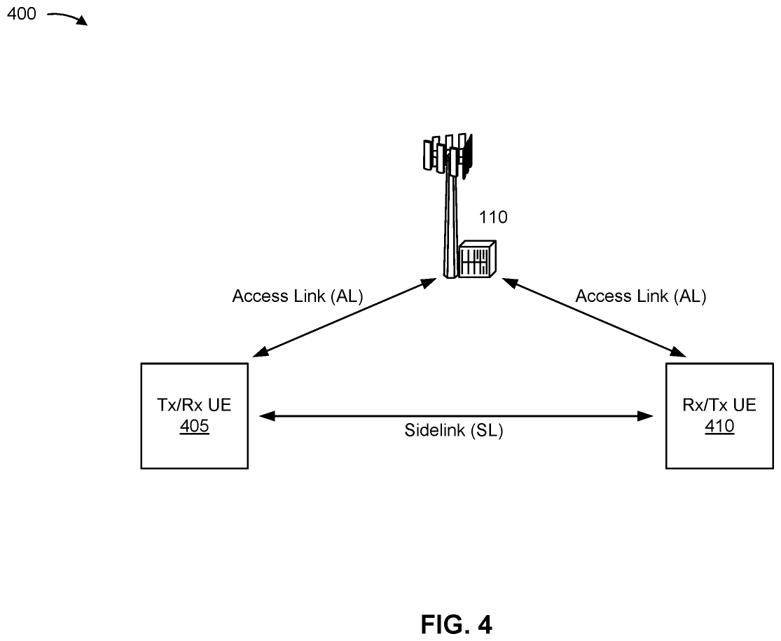

FIG. 4 is a diagram illustrating an example 400 of sidelink communications and access link communications, in accordance with the present disclosure. The description of example 400 provides UEs as examples of nodes which may perform the operations of example 400. However, example 400 can be implemented using another type of node, such as a wireless communication device other than a UE.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

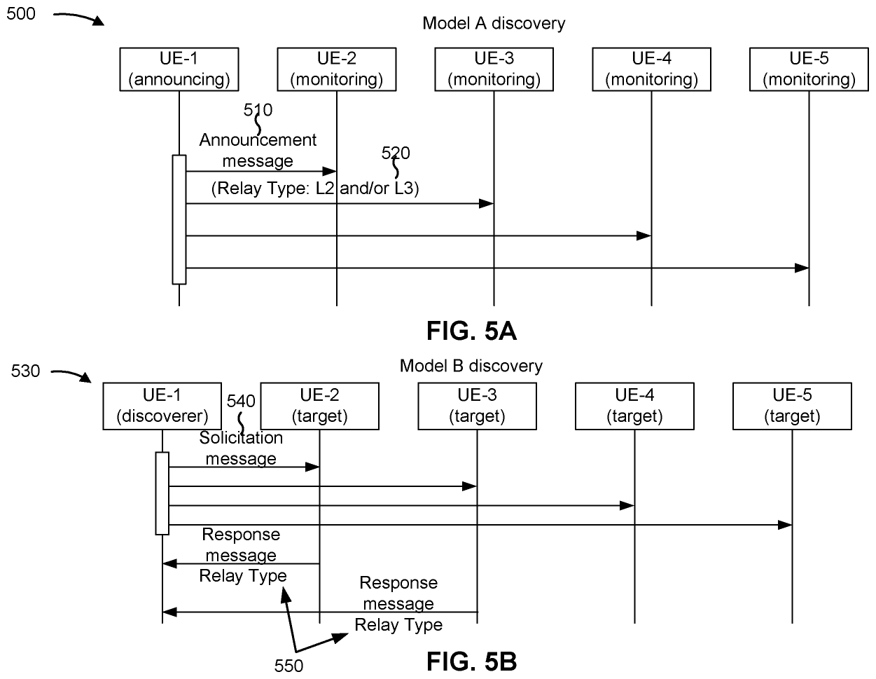

FIGS. 5A and 5B are diagram illustrating examples 500 and 530 of a first discovery model and a second discovery model for UEs performing sidelink communications, in accordance with the present disclosure. The description of examples 500 and 505 provides UEs as examples of nodes which may perform the operations of examples 500 and 505. However, examples 500 and 505 can be implemented using another type of node, such as a wireless communication device other than a UE.

The first discovery model may be referred to as Model A. In the first discovery model, a first UE (e.g., UE-1, or an announcing UE) may transmit an announcement message shown by reference number 510. As shown by reference number 520, the announcement message may indicate one or more relay types that the first UE is capable of performing (e.g., L2 relaying, Layer 3 relaying, unicast relaying, groupcast/broadcast relaying, and/or the like). For example, the announcement message may include a flag or field, such as a relay service code, indicating the one or more relay types. One or more second UEs (e.g., UE-2 through UE-5, or monitoring UEs) may monitor for the announcement message.

In example 530 of FIG. 5B, the second discovery model is illustrated. The second discovery model may be referred to as Model B. As shown, example 530 includes a discoverer UE (e.g., UE-1) and a set of target UEs (e.g., UE-2 through UE-5).

As shown by reference number 540, the discoverer UE may transmit a solicitation message. In some aspects, the solicitation message may indicate one or more relay types that the discoverer UE is capable of performing or desires to use (e.g., L2 relaying, Layer 3 relaying, unicast relaying, groupcast relaying, broadcast relaying, a combination thereof, and/or the like). For example, the solicitation message may include a flag or field, such as a relay service code, indicating the one or more relay types. As shown by reference number 550, target UEs that receive the solicitation message may provide a response message that indicates one or more relay types supported by the target UE. In some aspects, a target UE may respond if the target UE receives the solicitation message and supports a relay type indicated by the solicitation message.

In examples 500 and 530, a policy (e.g., a ProSe policy or the like) may provide authorization and/or operational parameters for the UEs of examples 500 and 530. For example, the authorization and/or operational parameters may indicate authorization or operational parameters associated with UE-to-UE relaying, described in more detail below. UEs in coverage of a network may receive such a policy from the network. UEs out of coverage of the network may use a preconfigured policy.

Discovery may be used to identify UEs for UE-to-UE relaying. A UE that identifies another UE according to the techniques described with regard to FIGS. 5A and 5B may be referred to as discovering the other UE. For example, a remote UE (which may be a source UE or a destination UE) may discover a relay UE using the technique described with regard to FIGS. 5A and 5B. As another example, a relay UE may discover a remote UE using Model A discovery. As yet another example, a relay UE may determine reachability of a remote UE via Model B discovery (e.g., the relay UE may transmit a solicitation message and may determine a remote UE is reachable if the remote UE responds to the solicitation message).

In some aspects, a discovery message (such as a solicitation message, a response to a solicitation message, or an announcement message) may include location information (e.g., a location identifier). For example, a UE transmitting a discovery message (e.g., a remote UE or a relay UE) may include the location information in the discovery message, or may transmit the location information with the discovery message. A discovery message associated with a relay node may include or be associated with location information for the relay node. In some aspects, the location information may include a zone identifier. For example, a sidelink radio access technology may provide for the division of an area into multiple zones, each of which is associated with a zone identifier. A relay UE may use the zone identifier to determine and/or store information indicating which remote UEs (e.g., destination UEs and/or source UEs) are reachable by the relay UE. For example, the relay UE may maintain a list of reachable remote UEs, which may indicate a range (e.g., a distance or a range of distances) to each of the reachable remote UEs (e.g., one range per reachable remote UE). The range may be determined based at least in part on the location information of the UE transmitting the discovery message and the location information of the UE receiving the discovery message. In some aspects, the relay UE may advertise the list of reachable remote UEs during discovery. For example, the relay UE may transmit information indicating the list of reachable remote UEs (e.g., an indication of one or more reachable remote UEs associated with the relay UE), such as via a discovery message. In this way, a source UE can identify one or more relay UEs for relaying a communication based at least in part on the remote UEs reachable by the one or more relay UEs. A UE may be considered reachable if the UE is within a threshold range of another UE, associated with a threshold signal strength at the other UE, associated with a capability indicating reachability, or the like.

As indicated above, FIGS. 5A and 5B are provided as examples. Other examples may differ from what is described with respect to FIGS. 5A and 5B.

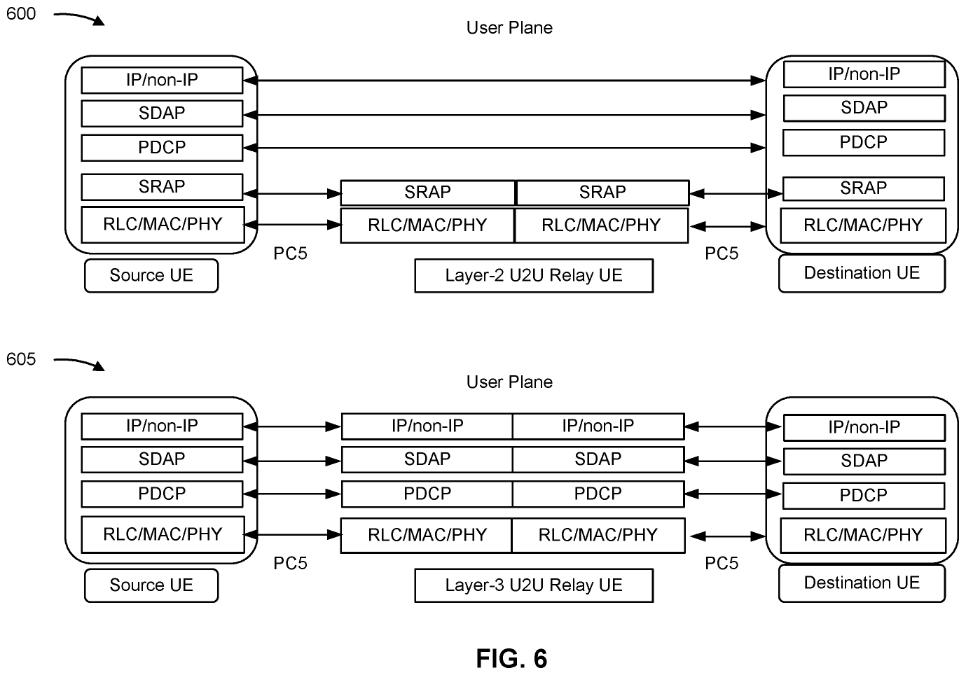

FIG. 6 is a diagram illustrating an example 600 of a user plane protocol stack for Layer 2 UE-to-UE relaying and an example 605 of a user plane protocol stack for Layer 3 UE-to-UE relaying, in accordance with the present disclosure. The description of examples 600 and 605 provides UEs as examples of nodes which may perform the operations of examples 600 and 605. However, examples 600 and 605 can be implemented using another type of node, such as a wireless communication device other than a UE. As shown, examples 600 and 605 include a source UE (e.g., UE 120, UE 305, UE 405), a relay UE (e.g., UE 120, UE 305, UE 405), and a destination UE (e.g., UE 120, UE 305, UE 405). As mentioned elsewhere herein, “remote UE” may refer to either the source UE or the destination UE. The UEs of examples 600 and 605 may communicate with one another via local links. The local links are illustrated as sidelink communication links (using a PC5 interface) but can include other forms of communication link (such as WiFi, Bluetooth, or the like).

The source UE may transmit a transmission. The relay UE may relay the transmission to the destination UE. In some aspects, the relay UE may relay the transmission to multiple destination UEs, such as via multi-node communication such as groupcast or broadcast signaling. The relaying of transmissions is described in more detail elsewhere herein.

As shown, the source UE, the destination UE, and the relay UE may be associated with respective lower-layer entities, such as a radio link control (RLC) entity, a medium access control (MAC) entity, a physical (PHY) entity, or the like.

As shown in examples 600 and 605, the source UE and the destination UE's user plane protocol stacks may include an IP or non-IP (IP/non-IP) entity, an SDAP component, and a PDCP component. Furthermore, as shown in example 605, the relay UE's user plane protocol stack for Layer 3 UE-to-UE relaying may include an IP/non-IP entity, an SDAP component, and a PDCP component, which may handle relaying based at least in part on Layer 3 identifiers, as described elsewhere herein.

As shown in example 600, in the user plane protocol stack for Layer 2 UE-to-UE relaying, the source UE, the relay UE, and the destination UE may each include an adaptation layer (e.g., adaptation layer entity), shown as a sidelink relay adaptation protocol (SRAP) layer entity. The adaptation layer entity of the relay UE may handle relaying from the source UE to the destination UE. In some aspects, the adaptation layer entity may be a separate entity between a radio link control entity and a packet data convergence entity. In some aspects, the adaptation layer entity may be logically part of the packet data convergence entity or the radio link control entity. In Layer 2 relaying, a PDCP packet is provided to the adaptation layer (that is, Layer 2) of the source UE with a header having routing information. The RLC/MAC/PHY layer of the relay UE may receive the packet and the header, and may provide the packet and the header to the adaptation layer of the relay UE. The adaptation layer of the relay UE may use the routing information indicated by the header to route the packet to the destination UE. The destination UE's RLC/MAC/PHY layer may receive the packet and provide the packet to the adaptation layer. The adaptation layer may remove a header from the packet and may provide the packet to the upper layer entities (e.g., PDCP/SDAP/IP/non-IP entities). Thus, Layer 2 relaying does not involve upper layer entities at the relay UE. Techniques described herein are also applicable for Layer 3 relaying. In Layer 3 relaying, relaying and routing is handled by an IP layer of the relay UE, the source UE, and the destination UE.

As indicated above, FIG. 6 is provided as an example. Other examples may differ from what is described with regard to FIG. 6.

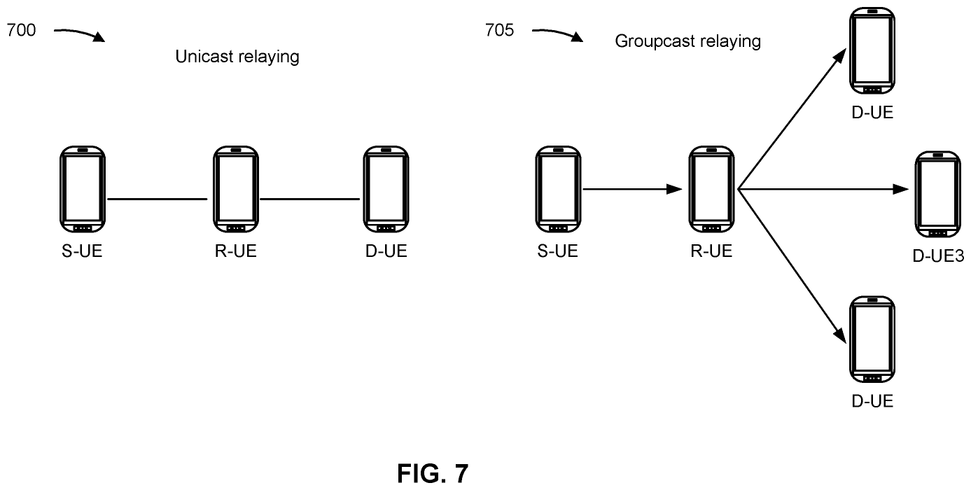

FIG. 7 is a diagram illustrating examples 700 and 705 of multi-node communication modes such as UE-to-UE relaying modes, in accordance with the present disclosure. The description of examples 700 and 705 provides UEs as examples of nodes which may perform the operations of examples 700 and 705. However, examples 700 and 705 can be implemented using another type of node, such as a wireless communication device other than a UE. Example 700 illustrates a unicast relaying mode. In the unicast relaying mode, there may be a hop-by-hop link. For example, in the unicast relaying mode, the source UE (e.g., UE 120, UE 305, UE 405) may establish a unicast link (e.g., a session) with the relay UE (e.g., UE 120, UE 305, UE 405), and the relay UE may establish a unicast link (e.g., a session) with the destination UE (e.g., UE 120, UE 305, UE 405). Furthermore, there may be a virtual unicast link (e.g., an end-to-end link) between the source UE and the destination UE, which may be established and/or maintained by a higher layer of the source UE and the destination UE (such as a PC5 signaling (PC5-S) entity, a radio resource control (RRC) entity, a PDCP entity, or the like).

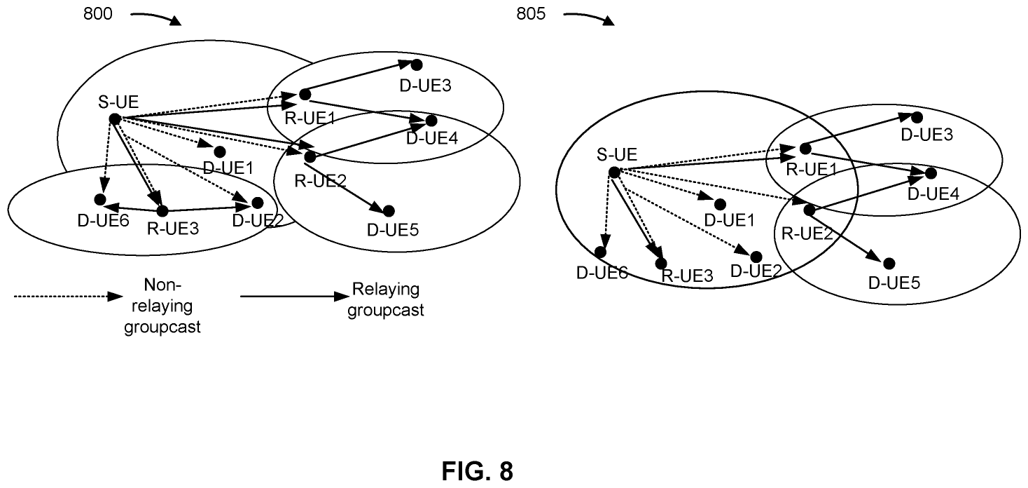

Techniques described herein provide groupcast relaying. An example of groupcast relaying is shown by example 705. In example 705, a source UE transmits a transmission via multi-node signaling, such as groupcast or broadcast signaling. A relay UE receives the transmission, and relays the transmission to one or more destination UEs (in example 705, three destination UEs) via multi-node signaling such as groupcast or broadcast signaling. In example 705, the transmission may not be relayed via a unicast link. For example, the relay UE may not establish a unicast link with the source UE and/or the destination UE(s), or may not use an existing unicast link to relay the transmission. Furthermore, in example 705, the transmission may not be associated with an end-to-end link between the source UE and the destination UE(s). It should be noted that, in some aspects, the source UE may transmit the transmission to multiple relays, one or more of which may relay the transmission via multi-node signaling to one or more destination UEs, as described in more detail in connection with FIG. 8.

As indicated above, FIG. 7 is provided as an example. Other examples may differ from what is described with regard to FIG. 7.

FIG. 8 is a diagram illustrating examples 800 and 805 of simple multi-node communication including groupcast relaying and selective groupcast relaying, in accordance with the present disclosure. The description of examples 800 and 805 provides UEs as examples of nodes which may perform the operations of examples 800 and 805. However, examples 800 and 805 can be implemented using another type of node, such as a wireless communication device other than a UE. Examples 800 and 805 illustrate how a set of relay UEs (R-UE1, R-UE2, and R-UE3) may relay a communication from a source UE (S-UE) to a set of destination UEs (D-UE1 through D-UE6). Each relay UE is associated with a range, shown by a corresponding oval. Destination UEs within the range of a relay UE may be reachable by the relay UE. For example, the relay UE may identify the destination UEs and/or the source UE as remote UEs according to the techniques described above with regard to FIGS. 5A and 5B. The source UE is also associated with a range, shown by a corresponding oval. Destination UEs and relay UEs within the range of the source UE may be reachable by the source UE.

Examples 800 and 805 illustrate transmissions (e.g., multi-node transmissions such as groupcast/broadcast transmissions) using a relaying multi-node communication mode (indicated by solid arrows, and which may be a relaying groupcast mode or a broadcast mode) and a non-relaying multi-node communication mode (indicated by dotted arrows, and which may be a non-relaying groupcast mode or broadcast mode). As shown, a transmission using the non-relaying multi-node communication mode may reach UEs within the range of the source UE, and may not be relayed by relay UEs. A non-relaying multi-node communication mode is a mode in which a transmission is not relayed by relay UEs that receive the transmission. As further shown, in both example 800 and 805, a transmission using the relaying multi-node communication mode may reach UEs within the range of the source UE, and may be relayed by one or more relay UEs. A relaying multi-node communication mode is a mode in which a transmission is relayed by one or more relay UEs that receive the transmission. Examples 800 and 805 differ with regard to which UEs relay a transmission that uses the relaying multi-node communication mode.

Example 800 shows simple groupcast relaying. The techniques described with regard to simple groupcast relaying are also applicable for simple broadcast relaying (in which a broadcast communication is relayed instead of a groupcast communication). In simple groupcast relaying, the source UE transmits a transmission using groupcast (e.g., broadcast) signaling to a group of UEs associated with a destination identifier (such as a Layer 3 identifier or a Layer 2 identifier). For example, the destination identifier may be associated with each of the relay UEs in range of the source UE. Each of the relay UEs that receives the transmission may relay the transmission to each destination UE in range of the relay UE. For example, R-UE3 relays to D-UE6 and D-UE2, R-UE2 relays to D-UE4 and D-UE5, and R-UE1 relays to D-UE3 and D-UE4. Simple groupcast relaying may be associated with lower overhead and processor usage at the source UE and/or the relay UE than selective groupcast relaying. It can be seen that some destination UEs may receive duplicated transmissions. For example, D-UE6 of example 800 receives the transmission from the source UE and from R-UE3. This may lead to data flooding and duplication of transmissions.

Example 805 shows selective relaying. The techniques described with regard to selective relaying are applicable for selective groupcast relaying and selective broadcast relaying (in which a broadcast communication is relayed instead of a groupcast communication). In selective relaying, a set of relay UEs may be selected to relay a transmission. For example, the source UE may select the set of relay UEs based at least in part on a configuration indicating how to select the set of relay UEs. In such examples, the transmission (or signaling associated with the transmission) or configuration signaling transmitted to a relay UE may indicate whether a relay UE is selected to relay the transmission. As another example, a relay UE may determine whether to relay a transmission based at least in part on a configuration indicating whether to relay the transmission. The transmission may be associated with a destination identifier, which may indicate a group of UEs that support multi-node communication relaying, as described in more detail elsewhere herein. The UEs of the group of UEs that receive the transmission based at least in part on the destination identifier may each selectively relay the transmission, such as based at least in part on a selective relaying configuration as described elsewhere herein. Selective relaying may provide less data flooding and duplication of transmissions than simple groupcast relaying, which improves efficiency of network resource utilization.

As indicated above, FIG. 8 is provided as an example. Other examples may differ from what is described with regard to FIG. 8.

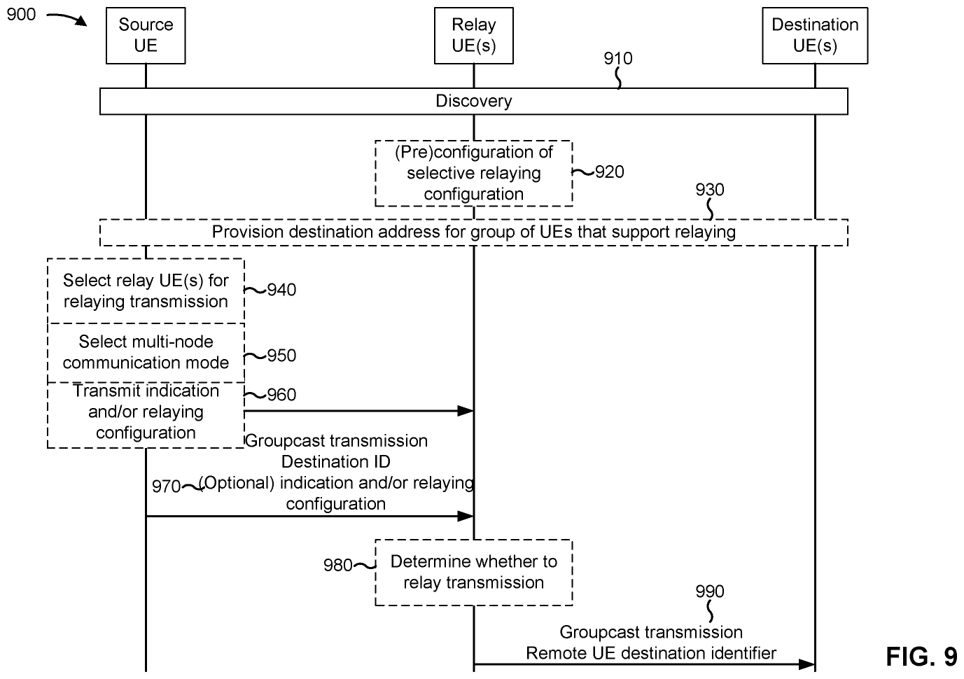

FIG. 9 is a diagram illustrating an example 900 of groupcast or broadcast relaying, in accordance with the present disclosure. Example 900 includes a source UE (e.g., UE 120, UE 305, UE 405), a relay UE (e.g., UE 120, UE 305, UE 405), and one or more destination UEs (e.g., UE 120, UE 305, UE 405). For simplicity and clarity, a single relay UE is described in example 900. However, it should be understood that the techniques described herein are applicable for multiple relay UEs, as shown, for example, in FIG. 8. Furthermore, the description of example 900 provides UEs as examples of nodes which may perform the operations of example 900. However, example 900 can be implemented using another type of node, such as a wireless communication device other than a UE.

Example 900 relates to relaying of a transmission by a relay UE. In some aspects, the source UE may transmit the transmission as a groupcast transmission. A groupcast transmission is directed to a group of UEs, which may be associated with an identifier. The groupcast transmission may be associated with a feedback mechanism, such as a negative acknowledgment (NACK) only feedback mechanism (e.g., for connection-less groupcast with or without a range requirement), or an acknowledgment (ACK)/NACK feedback mechanism (e.g., for connection managed groupcast per UE in the group of UEs). In some cases, the source UE may transmit the transmission as a broadcast transmission. In some cases, a broadcast transmission may be a communication of information to all UEs within the range of the source UE. In some cases, the source UE may not be aware of whether or not individual UEs 120, of the set of UEs 120, have received the information using the broadcast communication. In some cases, the broadcast communication may not be associated with feedback. In some cases, the broadcast communication may referred to as a “one-to-all” communication. Groupcast communications and broadcast communications are collectively referred to herein as multi-node communications. A non-relaying multi-node communication mode can be a non-relaying groupcast mode or a non-relaying broadcast mode. A relaying multi-node communication mode can be a relaying groupcast mode or a relaying broadcast mode.

As shown by reference number 910, the source UE, the relay UE, and the destination UE(s) may perform discovery. For example, the source UE, the relay UE, and the destination UE(s) may discover one another as described in more detail in connection with FIGS. 5A and 5B. In some aspects, the relay UE may store and/or provide information indicating the source UE and the one or more destination UEs.

As shown by reference number 920, in some aspects, the relay UE may be configured or preconfigured with a selective relaying configuration. A selective relaying configuration is a configuration that indicates one or more parameters that a relay UE may use to determine whether a transmission should be relayed by the relay UE. The one or more parameters can include, for example, a link quality associated with the relay UE (e.g., in terms of sidelink discovery reference signal received power (SD-RSRP), sidelink reference signal received power (SL-RSRP), or another link quality metric, between the relay UE and one or more destination UEs), whether the relay UE supports relaying for a group identifier (e.g., a group identifier associated with the source UE and/or the one or more destination UEs), a location associated with the relay UE (e.g., whether the relay UE is within a same zone as the source UE and/or within a threshold distance of the source UE), a number of UEs reachable by the relay UE or within a threshold range of the relay UE (e.g., whether the relay UE has at least a threshold number or percentage of destination UEs reachable and within a threshold distance of the relay UE), or the like. The relay UE may determine whether to relay a transmission based at least in part on the one or more parameters, as described below. In some aspects, the relay UE may be preconfigured with the selective relaying configuration, such as using a default configuration, a baseline configuration received from a network entity, or the like. In some aspects, the relay UE may receive the configuration from the source UE (e.g., via an indication of a relaying configuration, as described below). In some aspects, the relay UE may receive the configuration from a network entity, such as a base station, a central unit, a distributed unit, a radio unit, or the like. For example, the relay UE may receive the configuration via a system information block, dedicated RRC signaling, or the like.

In some aspects, the relay UE may receive a multi-node communication relaying table (such as in a relaying configuration received from the source UE, or in a configuration received from another node, such as a network entity). As mentioned above, a selective relaying configuration is a configuration that indicates one or more parameters that a relay UE may use to determine whether a transmission should be relayed by the relay UE. A source UE may provide a relaying configuration and/or an indication associated with a relaying configuration to a relay UE, as described below. For example, the indication may include a notification to relay a communication or to activate relaying (such as in a data protocol data unit (PDU) header or out-of-band control signaling). As another example, the relaying configuration may include the multi-node communication relaying table, and the multi-node communication relaying table may include the selective relaying configuration.

A multi-node communication relaying table is a data structure that includes information used by a relay UE to relay (or selectively relay) a transmission. In some aspects, the multi-node communication relaying table may indicate whether to perform multi-node communication relaying (e.g., whether the relay UE supports a relaying multi-node communication mode, whether groupcast relaying is activated or deactivated for a communication matching parameters of the multi-node communication relaying table, whether groupcast relaying is activated or deactivated for the relay UE). In some aspects, the multi-node communication relaying table may indicate a source address (e.g., an address of a source UE for which relaying is to be performed). In some aspects, the multi-node communication relaying table may indicate a remote UE destination identifier (e.g., an address of a destination UE or group of destination UEs to which a transmission is to be relayed). In some aspects, the multi-node communication relaying table may include the selective relaying configuration. In some aspects, the multi-node communication relaying table may indicate a set of relay UEs selected by a source UE for relaying (e.g., based at least in part on one or more identifiers of the set of relay UEs, such as Layer 2 identifiers or the like). In some aspects, the source address and/or the destination address may be a wildcard address. A wildcard address indicates that a transmission associated with any address should be relayed. For example, a wildcard source address associated with a particular destination address may indicate that transmissions to the particular destination address should be relayed, no matter which source address is associated with the transmissions.

An example of a multi-node communication relaying table is provided below:
Multi-node communication relaying table
   Groupcast/broadcast relaying-true or false
   Source address
   Destination address
   Selective relaying configuration
   Set of selected relay UEs (relay UE identifiers)

In some aspects, the relay UE may determine a multi-node communication relaying table, such as one or more parameters of the multi-node communication relaying table (e.g., whether groupcast relaying is activated or deactivated for a communication matching parameters of the multi-node communication relaying table, a source address, a destination address, a selective relaying configuration, one or more relay UE identifiers, or the like). For example, the relay UE may receive, from one or more remote UEs (e.g., one or more source UEs, one or more other relay UEs, one or more destination UEs), signaling such as control signaling. The signaling may indicate at least one of a link quality (e.g., SD-RSRP, SL-RSRP, or the like), one or more zone identifiers of the one or more remote UEs, one or more ranges of the one or more remote UEs from the relay UE, one or more group identifiers of one or more groups interested in relaying, or the like. The relay UE may determine a multi-node communication relaying table based at least in part on the receive signaling and/or other information. For example, the relay UE may determine one or more parameters of a multi-node communication relaying table (which may include determining a selective relaying configuration) based at least in part on determination of one or more metrics (e.g., link quality, range, etc.) of the one or more remote UEs and/or other UEs. Determining the selective relaying configuration and/or the multi-node communication relaying table at the relay UE may conserve processing resources of a network entity.

In some aspects, the relay UE may receive the multi-node communication relaying table and/or one or more parameters associated with the multi-node communication relaying table (such as a selective relaying configuration), as described above. For example, the relay UE may report, to a network entity (such as a relaying controller), one or more metrics such as at least one of a link quality (e.g., SD-RSRP, SL-RSRP, or the like), one or more zone identifiers of the one or more remote UEs, one or more ranges of the one or more remote UEs from the relay UE, one or more group identifiers of one or more groups interested in relaying, or the like. The network entity may determine a multi-node communication relaying table based at least in part on the one or more metrics. The network entity may signal, to the relay UE (e.g., via control signaling), information indicating the multi-node communication relaying table. In some aspects, the network entity may signal the selective relaying configuration, and the relay UE may determine the multi-node communication relaying table based at least in part on the selective relaying configuration. In some aspects, the network entity may signal one or more parameters of the multi-node communication relaying table, and the relay UE may determine the multi-node communication relaying table based at least in part on the one or more parameters.

As shown by reference number 930, the source UE, the relay UE, and/or the one or more destination UE may be provisioned with a destination address. In some aspects, only the source UE and the relay UE may be provisioned with the destination address. In some aspects, the source UE, the relay UE, and the one or more destination UEs may be provisioned with the destination address. In some aspects, the destination address may be a Layer 2 identifier. In some aspects, the destination address may be referred to as an “all relay UEs groupcast destination Layer 2 identifier.” In some aspects, the destination address may be a Layer 3 identifier. The destination address may be an address associated with a group of relay UEs that are to relay a communication.

In some aspects, a destination address may be associated with a group identifier. A group identifier may indicate a group of UEs that support or are configured for UE-to-UE relaying. In some aspects, there may be one destination address per group identifier.

In some aspects, the source UE may be associated with a source UE identifier (e.g., a Layer 2 identifier). In some aspects, the relay UE may be associated with a relay UE identifier (e.g., a relay UE identifier). In some aspects, a destination UE or a group of destination UEs may be associated with an identifier. For example, a group of destination UEs to which a relay UE relays a groupcast or broadcast transmission may be identified by a group identifier (e.g., a Layer 2 identifier).

As shown by reference number 940, in some aspects, the source UE may select one or more relay UEs to relay a transmission. For example, the source UE may select the one or more relay UEs based at least in part on discovering the one or more relay UEs. In some aspects, the source UE may select a relay UE based at least in part on one or more thresholds associated with one or more parameters (described below). For example, the one or more thresholds may be preconfigured for the source UE. As another example, the one or more thresholds may be received via control signaling, such as a system information block. In some aspects, the source UE may be associated with multiple thresholds, such as a first threshold associated with selecting a relay UE for unicast relaying and a second threshold associated with selecting a relay UE for groupcast relaying.

In some aspects, the source UE may select a relay UE based at least in part on a discovery message, such as a discovery announcement message or a response to a discovery message. For example, a discovery message may indicate one or more group identifiers for which the relay UE supports relaying. As another example, the discovery message may indicate one or more group identifiers for which there is at least one UE (e.g., destination UE) in range of the relay UE. For example, the determination of whether the at least one UE is in range of the relay UE may be based at least in part on an advertisement of the at least one UE supporting a group identifier, a path discovery (e.g., indicating that the at least one UE is associated with a neighbor or path relationship with the relay UE), or a combination thereof.

In some aspects, the source UE may select the relay UE based at least in part on one or more parameters. The one or more parameters can include, for example, a link quality associated with the relay UE (e.g., in terms of sidelink discovery reference signal received power (SD-RSRP), sidelink reference signal received power (SL-RSRP), or another link quality metric, between the relay UE and one or more destination UEs), whether the relay UE supports relaying for a group identifier (e.g., a group identifier associated with the source UE and/or the one or more destination UEs), a location associated with the relay UE (e.g., whether the relay UE is within a same zone as the source UE and/or within a threshold distance of the source UE), a number of UEs reachable by the relay UE or within a threshold range of the relay UE (e.g., whether the relay UE has at least a threshold number or percentage of destination UEs reachable and within a threshold distance of the relay UE), a loading metric associated with the relay UE (which may be indicated to the source UE or the destination UE by the relay UE, and which may indicate a traffic load associated with the relay UE), or a power metric associated with the relay UE (which may be indicated to the source UE or the destination UE by the relay UE, and which may indicate a power level, power usage, power headroom, or the like). In some aspects, the source UE may measure a link quality between the source UE and the relay UE. The source UE may receive, from the relay UE, an indication of a link quality between the relay UE and one or more destination UEs. The source UE may select the relay UE based at least in part on one or more of these link qualities.

As shown by reference number 950, in some aspects, the source UE may select a multi-node communication mode. In some aspects, the source UE may select the multi-node communication mode prior to selecting the one or more relay UEs described in connection with reference number 940. The multi-node communication mode may be selected from a relaying multi-node communication mode (indicated by solid lines in FIG. 8) and a non-relaying multi-node communication mode (indicated by dashed lines in FIG. 8). In some aspects, the source UE may use both a relaying multi-node communication mode and a non-relaying multi-node communication mode. For example, the source UE may transmit a transmission using both the relaying multi-node communication mode and the non-relaying multi-node communication mode. In some aspects, the source UE may select the multi-node communication mode based at least in part on a number of received acknowledgments or a number of retransmissions. For example, the source UE may use a non-relaying multi-node communication mode if the number of received ACKs (or a number of received NACKs, or a ratio of ACKs to NACKs) fails to satisfy a threshold (indicating satisfactory reliability of groupcast transmissions), or may use the relaying multi-node communication mode if the received ACKs (or the number of received NACKs, or the ratio of ACKs to NACKs) satisfies the threshold (indicating unsatisfactory reliability of groupcast transmissions). As another example, the source UE may use a non-relaying multi-node communication mode if a number of retransmissions is lower than a threshold, or may use a relaying multi-node communication mode if the number of retransmissions is higher than or equal to the threshold. By using the relaying multi-node communication mode when the number of retransmissions is higher than or equal to the threshold, the source UE may improve coverage by triggering relay UEs to relay the message.

As shown by reference number 960, in some aspects, the source UE may transmit a relaying configuration and/or an indication associated with a relaying configuration. The relaying configuration may include one or more parameters of a multi-node communication relaying table, such as a selective relaying configuration or one or more parameters described herein.

In some aspects, the source UE may transmit the indication associated with the relaying configuration in association with the transmission. For example, the transmission may include the indication. In some aspects, the indication may be a value of a field of a data protocol data unit (PDU) header of the transmission (e.g., an application layer header or a Layer 2 header) that indicates for the relay UE to relay the transmission. In such examples, the relay UE may relay the transmission based at least in part on the indication and a multi-node relaying communication table. In some other aspects, the source UE may transmit the indication associated with the relaying configuration separately from the transmission. For example, the indication may be transmitted via out-of-band signaling such as out-of-band control signaling. Out-of-band signaling is signaling separate from data communication of the UE. Examples of out-of-band signaling include an application-layer control PDU, a medium access control (MAC) control element (MAC-CE), sidelink control information (e.g., a second stage of sidelink control information), or the like. A relay UE may follow a most recently received indication or relaying configuration, until the relay UE receives an updated indication or relaying configuration. For example, the relaying UE may activate relaying of communications, in accordance with the indication or relaying configuration, until another indication is received indicating to deactivate the relaying of communications or change a configuration for the relaying of communications.

As shown by reference number 970, the source UE may transmit a transmission. For example, the source UE may transmit the transmission using the selected multi-node communication mode (such as via groupcast signaling or broadcast signaling). In some aspects, the transmission may include a header, such as an application layer header or a data PDU header. In some aspects, the header may include an indication associated with a relaying configuration, such as in a field of the header. For example, the indication included in the header may indicate for the relay UE to relay the transmission to one or more destination UEs. In such examples, the source UE may include the indication in the header so that the source UE can select appropriate relay UEs for relaying (as compared to a simple groupcast approach). In some aspects, the header may include a sequence number. For example, the sequence number may provide for detection of duplicate transmissions and duplicate handling at the relay UE or a destination UE (such as by determining if a transmission with the same sequence number as a given transmission has been previously received). In some aspects, the transmission may be directed to a destination identifier (e.g., an “all relay UEs groupcast destination Layer 2 identifier”), which may include a Layer 3 identifier or a Layer 2 identifier associated with relay UEs that are to relay the transmission. For example, a MAC or PHY layer field of the transmission may indicate the destination identifier.

As shown by reference number 980, in some aspects, the relay UE may determine whether to relay the transmission. In some aspects, the relay UE may relay the transmission based at least in part on the destination identifier. For example, the relay UE may relay the transmission based at least in part on the transmission being associated with a particular destination identifier (e.g., a destination identifier designated for multi-node communication relaying). As another example, the relay UE may relay the transmission based at least in part on the indication being present in the header of the transmission. In some aspects, the relay UE may selectively relay the transmission. For example, the relay UE may selectively relay the transmission based at least in part on a selective relaying configuration, as described above in connection with reference number 920. In such examples, the relay UE may relay the transmission if the transmission satisfies a condition associated with one or more parameters of the selective relaying configuration, and may determine not to relay the transmission (e.g., may consume the transmission) if the condition associated with the one or more parameters is not satisfied. For example, the relay UE may relay the transmission if a link quality between the relay UE and the one or more destination UEs satisfies a threshold. As another example, the relay UE may relay the transmission if the relay UE supports relaying for a group identifier associated with the transmission. As yet another example, the relay UE may relay the transmission if the relay UE is within a same zone or within a threshold distance of the source UE. As still another example, the relay UE may relay the transmission if a number of destination UEs reachable by the relay UE satisfies a threshold. In some aspects, the relay UE may determine whether to relay the transmission based at least in part on a combination of the above factors.

In some aspects, the relay UE may receive the selective relaying configuration from a network entity such as a base station, a CU, or a DU. For example, the relay UE, a source UE, and/or a destination UE may provide information indicating one or more parameters to the network entity. The one or more parameters can include any parameter described above with regard to reference number 920. For example, the relay UE may provide information regarding one or more parameters at the relay UE. As another example, a remote UE (e.g., a source UE or a destination UE) may provide information regarding one or more parameters at the remote UE. The network entity may use information regarding one or more relay UEs and/or information regarding one or more remote UEs to determine a selective relaying configuration, and may provide the selective relaying configuration to one or more relay UEs.

As shown by reference number 990, the relay UE may relay the transmission. For example, the relay UE may relay the transmission to one or more destination UEs. The relay UE may relay the transmission in accordance with the relaying configuration (such as one or more parameters of a multi-node communication relaying table indicated by the relaying configuration, a destination identifier indicated by the relaying configuration, or the like) and/or the selective relaying configuration. For example, the relay UE may determine to relay the transmission based at least in part on the relaying configuration and/or the selective relaying configuration, and may relay the transmission to the one or more destination UEs using information indicated by the relaying configuration. In some aspects, the relay UE may relay the transmission using information (e.g., a source identifier, a destination identifier, a remote UE destination identifier, or the like) indicated by a multi-node communication relaying table. For example, the relay UE may identify one or more destination UEs in accordance with the multi-node communication relaying table (based at least in part on one or more conditions of the selective relaying configuration being satisfied for the transmission) and may generate a groupcast or broadcast transmission to the one or more destination UEs that relays the received transmission.

In some aspects, the relay UE may remove a header from the transmission. For example, the header may include an indication associated with a relaying configuration (which triggers the relay UE to relay the transmission), the relay UE may remove the header such that the transmission is not relayed by the one or more destination UEs. In some aspects, the transmission, as received by the relay UE, may include a source UE identifier (e.g., a Layer 2 identifier) and a destination identifier (e.g., the group identifier associated with relaying). The transmission, as relayed by the relay UE, may include an identifier of the relay UE (e.g., a Layer 2 identifier) and an identifier of one or more destination UEs (e.g., a destination UE Layer 2 identifier associated with groupcast).

While the techniques above are, in some cases, described with regard to groupcast relaying, these techniques can readily be applied for broadcast relaying. It should be understood that “groupcast” in FIG. 9 and the accompanying description can refer to a groupcast transmission (such as associated with a feedback mechanism and/or to a defined group of network nodes) or to a broadcast transmission (such as associated with no feedback mechanism and/or to all network nodes within range of the source network node).

As indicated above, FIG. 9 is provided as an example. Other examples may differ from what is described with regard to FIG. 9.

FIG. 10 is a diagram illustrating an example process 1000 performed, for example, by a source node, in accordance with the present disclosure. Example process 1000 is an example where the source node (e.g., UE 120, UE 305, UE 405, UE 410, one or more of the UEs of FIG. 5, the source UE of FIG. 6, the source UE of FIG. 7, the source UE of FIG. 8, or the source UE of FIG. 9) performs operations associated with groupcast or broadcast UE-to-UE relaying.

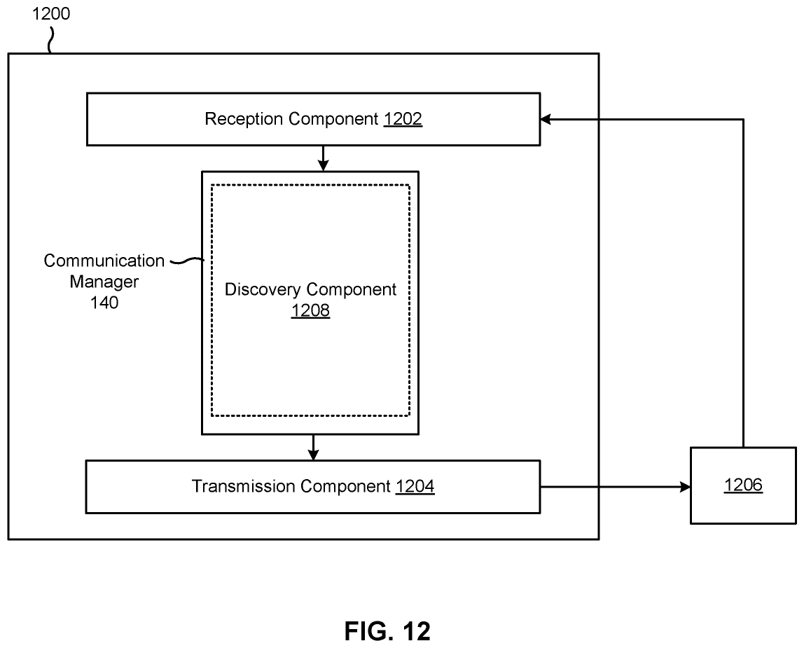

As shown in FIG. 10, in some aspects, process 1000 may include discovering one or more relay nodes (block 1010). For example, the source node (e.g., using communication manager 140 and/or discovery component 1208, depicted in FIG. 12) may discover one or more relay nodes, as described above.

As further shown in FIG. 10, in some aspects, process 1000 may include transmitting a relaying configuration or an indication associated with the relaying configuration, wherein the relaying configuration is associated with a selected multi-node communication mode including at least one of a relaying multi-node communication mode or a non-relaying multi-node communication mode (block 1020). For example, the source node (e.g., using communication manager 140 and/or transmission component 1204, depicted in FIG. 12) may transmit a relaying configuration or an indication associated with the relaying configuration, wherein the relaying configuration is associated with a selected multi-node communication mode including at least one of a relaying multi-node communication mode or a non-relaying multi-node communication mode, as described above. The relaying configuration, or the indication, may be associated with the selected multi-node communication mode. For example, the relaying configuration or the indication may indicate that relay UEs using the selected multi-node communication node are to relay a transmission. As another example, the relaying configuration may include a selective relaying configuration that indicates one or more parameters that a relay UE may use to determine whether a transmission, associated with the relaying multi-node communication node, should be relayed by the relay UE.

As further shown in FIG. 10, in some aspects, process 1000 may include transmitting a transmission to the one or more relay nodes based at least in part on the selected multi-node communication mode or the relaying configuration (block 1030). For example, the source node (e.g., using communication manager 140 and/or transmission component 1204, depicted in FIG. 12) may transmit a transmission to the one or more relay nodes based at least in part on the selected multi-node communication mode or the relaying configuration, as described above. For example, the source node may transmit the transmission to the one or more relay nodes based at least in part on the transmission indicating a destination identifier of the one or more relay nodes or based at least in part on the one or more relay nodes being in a broadcast range of the source node.

Process 1000 may include additional aspects, such as any single aspect or any combination of aspects described below and/or in connection with one or more other processes described elsewhere herein.

In a first aspect, process 1000 includes selecting the selected multi-node communication mode for the transmission.

In a second aspect, alone or in combination with the first aspect, discovering the one or more relay nodes is based at least in part on a location identifier indicated in one or more discovery messages associated with the one or more relay nodes.

In a third aspect, alone or in combination with one or more of the first and second aspects, discovering the one or more relay nodes further comprises receiving an indication of one or more reachable remote nodes associated with a relay node of the one or more relay nodes.

In a fourth aspect, alone or in combination with one or more of the first through third aspects, the indication of the one or more reachable remote nodes is based at least in part on one or more location identifiers associated with the one or more reachable remote nodes.

In a fifth aspect, alone or in combination with one or more of the first through fourth aspects, discovering the one or more relay nodes further comprises receiving a relaying support indication of whether the one or more relay nodes support unicast relaying, groupcast relaying, broadcast relaying, both unicast relaying and groupcast relaying, or all of unicast relaying, groupcast relaying, and broadcast relaying, wherein the selected multi-node communication mode is based at least in part on the relaying support indication.

In a sixth aspect, alone or in combination with one or more of the first through fifth aspects, the selected multi-node communication mode is the relaying multi-node communication mode, and wherein transmitting the transmission to the one or more relay nodes further comprises transmitting the transmission to a destination identifier, a Layer 3 identifier, or a Layer 2 identifier, associated with a group of nodes.

In a seventh aspect, alone or in combination with one or more of the first through sixth aspects, the destination identifier is associated with a group identifier corresponding to the group of nodes including the one or more relay nodes.

In an eighth aspect, alone or in combination with one or more of the first through seventh aspects, the destination identifier indicates to relay if the transmission is a groupcast transmission.

In a ninth aspect, alone or in combination with one or more of the first through eighth aspects, the selected multi-node communication mode includes the relaying multi-node communication mode, and wherein a header of the transmission indicates that the transmission is associated with the relaying multi-node communication mode.

In a tenth aspect, alone or in combination with one or more of the first through ninth aspects, the header includes a sequence number associated with duplicate handling.

In an eleventh aspect, alone or in combination with one or more of the first through tenth aspects, the transmission includes the indication in a header associated with the transmission.

In a twelfth aspect, alone or in combination with one or more of the first through eleventh aspects, process 1000 includes selecting the one or more relay nodes to relay the transmission.

In a thirteenth aspect, alone or in combination with one or more of the first through twelfth aspects, selecting the one or more relay nodes is based at least in part on at least one of a link quality associated with the one or more relay nodes, whether the one or more relay nodes support relaying for a group identifier, one or more locations associated with the one or more relay nodes, a loading or power metric of the one or more relay nodes, or a number of nodes reachable by the one or more relay nodes or within a threshold range of the one or more relay nodes.

In a fourteenth aspect, alone or in combination with one or more of the first through thirteenth aspects, selecting the one or more relay nodes is based at least in part on discovering the one or more relay nodes.

In a fifteenth aspect, alone or in combination with one or more of the first through fourteenth aspects, the transmission includes an indication of a group identifier corresponding to a group of destination nodes for the selected multi-node communication mode.

In a sixteenth aspect, alone or in combination with one or more of the first through fifteenth aspects, process 1000 includes transmitting the transmission using the relaying multi-node communication mode and the non-relaying multi-node communication mode.

In a seventeenth aspect, alone or in combination with one or more of the first through sixteenth aspects, process 1000 includes selecting the multi-node communication mode based at least in part on a number of received acknowledgments or a number of retransmissions.

In an eighteenth aspect, alone or in combination with one or more of the first through seventeenth aspects, the relaying configuration includes a selective relaying configuration that indicates one or more parameters associated with determining whether the transmission is to be relayed.

In a nineteenth aspect, alone or in combination with one or more of the first through eighteenth aspects, the one or more parameters include at least one of a link quality associated with the one or more relay nodes, whether the one or more relay nodes support relaying for a group identifier, a location associated with the one or more relay nodes, a loading or power metric of the one or more relay nodes, or a number of nodes reachable by the one or more relay nodes or within a threshold range of the one or more relay nodes.

In a twentieth aspect, alone or in combination with one or more of the first through nineteenth aspects, the relaying configuration is transmitted via at least one of a header of a data protocol data unit (PDU), a control PDU, medium access signaling, sidelink control information, or controlling signaling.

In a twenty-first aspect, alone or in combination with one or more of the first through twentieth aspects, the relaying configuration indicates a set of parameters of a multi-node communication relaying table including at least one of whether the relaying configuration is associated with the relaying multi-node communication mode, a source address, a destination identifier corresponding to a group identifier, the group identifier, or one or more identifiers of the one or more relay nodes. In some aspects, the multi-node communication relaying table includes the selective relaying configuration.

In a twenty-second aspect, alone or in combination with one or more of the first through twenty-first aspects, a discovery message received from the one or more relay nodes indicates a set of group identifiers for which groupcast relaying is supported.

In a twenty-third aspect, alone or in combination with one or more of the first through twenty-second aspects, the set of group identifiers are associated with one or more destination nodes that are in range of the one or more relay nodes.

In a twenty-fourth aspect, alone or in combination with one or more of the first through twenty-third aspects, the transmission is a broadcast transmission that does not utilize feedback and the selected multi-node communication mode is a broadcast communication mode.

In a twenty-fifth aspect, alone or in combination with one or more of the first through twenty-fourth aspects, the transmission is a groupcast transmission that utilizes feedback and the selected multi-node communication mode is a groupcast communication mode.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a relay node, in accordance with the present disclosure. Example process 1100 is an example where the relay node (e.g., UE 120, UE 305, UE 405, UE 410, one or more of the UEs of FIG. 5, the relay UE of FIG. 6, the relay UE of FIG. 7, the relay UE of FIG. 8, or the relay UE of FIG. 9) performs operations associated with groupcast or broadcast UE-to-UE relaying.

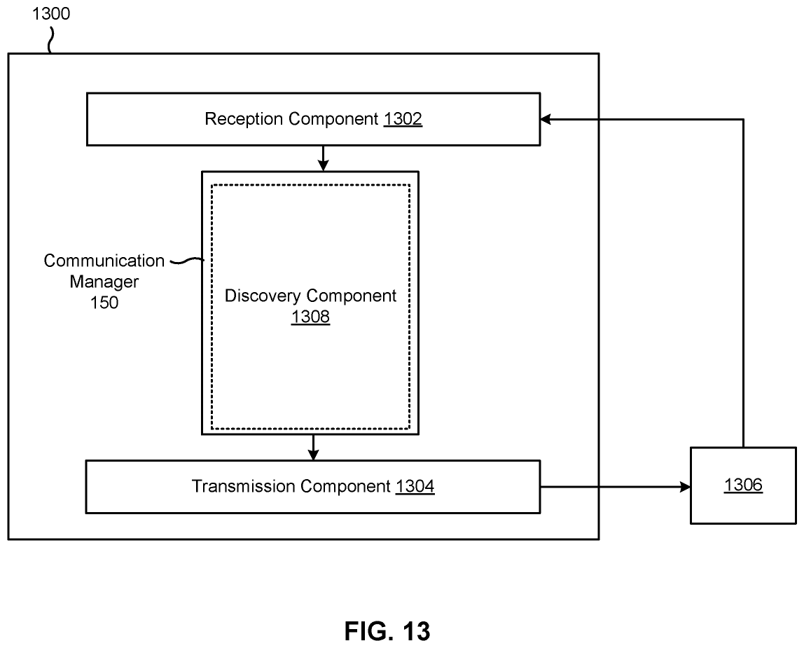

As shown in FIG. 11, in some aspects, process 1100 may include discovering a source node and one or more destination nodes (block 1110). For example, the relay node (e.g., using communication manager 150 and/or discovery component 1308, depicted in FIG. 13) may discover a source node and one or more destination nodes, as described above.

As further shown in FIG. 11, in some aspects, process 1100 may include receiving a relaying configuration or an indication associated with the relaying configuration associated with a relaying multi-node communication mode (block 1120). For example, the relay node (e.g., using communication manager 150 and/or reception component 1302, depicted in FIG. 13) may receive a relaying configuration or an indication associated with the relaying configuration associated with a relaying multi-node communication mode, as described above.

As further shown in FIG. 11, in some aspects, process 1100 may include receiving a transmission from the source node (block 1130). For example, the relay node (e.g., using communication manager 150 and/or reception component 1302, depicted in FIG. 13) may receive a transmission from the source node, as described above.

As further shown in FIG. 11, in some aspects, process 1100 may include relaying the transmission to the one or more destination nodes based at least in part on the relaying configuration (block 1140). For example, the relay node (e.g., using communication manager 150 and/or transmission component 1304, depicted in FIG. 13) may relay the transmission to the one or more destination nodes based at least in part on the relaying configuration, as described above.

Process 1100 may include additional aspects, such as any single aspect or any combination of aspects described below and/or in connection with one or more other processes described elsewhere herein.

In a first aspect, the indication is received from the source node.

In a second aspect, alone or in combination with the first aspect, discovering the source node and the one or more destination nodes is based at least in part on a location identifier indicated in one or more discovery messages received by the relay node.

In a third aspect, alone or in combination with one or more of the first and second aspects, process 1100 includes transmitting a discovery message including an indication of one or more reachable remote nodes associated with the relay node.

In a fourth aspect, alone or in combination with one or more of the first through third aspects, the indication of the one or more reachable remote nodes is based at least in part on one or more location identifiers associated with the one or more reachable remote nodes.

In a fifth aspect, alone or in combination with one or more of the first through fourth aspects, process 1100 includes transmitting a relaying support indication of whether the relay node supports unicast relaying, groupcast relaying, broadcast relaying, both unicast relaying and groupcast relaying, or all of unicast relaying, groupcast relaying, and broadcast relaying.

In a sixth aspect, alone or in combination with one or more of the first through fifth aspects, the transmission is directed to a destination identifier associated with a group of relay nodes including the relay node.

In a seventh aspect, alone or in combination with one or more of the first through sixth aspects, the destination identifier is associated with a group identifier corresponding to the group of relay nodes including the relay node.

In an eighth aspect, alone or in combination with one or more of the first through seventh aspects, the destination identifier indicates to relay if the transmission is a groupcast transmission.

In a ninth aspect, alone or in combination with one or more of the first through eighth aspects, a header of the transmission indicates that the transmission is associated with the relaying multi-node communication mode.

In a tenth aspect, alone or in combination with one or more of the first through ninth aspects, the header includes a sequence number associated with duplicate handling.

In an eleventh aspect, alone or in combination with one or more of the first through tenth aspects, the transmission includes an indication for the relay node to relay the transmission.

In a twelfth aspect, alone or in combination with one or more of the first through eleventh aspects, process 1100 includes determining whether to relay the transmission.

In a thirteenth aspect, alone or in combination with one or more of the first through twelfth aspects, determining whether to relay the transmission further comprises determining whether to relay the transmission based at least in part on a selective relaying configuration, wherein the selective relaying configuration is based at least in part on one or more parameters including at least one of: at least one of a link quality associated with the relay node, whether the relay node supports relaying for a group identifier, one or more locations associated with the relay node, the source node, or the one or more destination nodes, a loading or power metric of the relay node, or a number of destination nodes reachable by the relay node or within a threshold range of the relay node.

In a fourteenth aspect, alone or in combination with one or more of the first through thirteenth aspects, the selective relaying configuration is received in the relaying configuration.

In a fifteenth aspect, alone or in combination with one or more of the first through fourteenth aspects, process 1100 includes receiving signaling indicating the one or more parameters, and determining the selective relaying configuration based at least in part on at least one of the signaling or a metric determined by the relay node.

In a sixteenth aspect, alone or in combination with one or more of the first through fifteenth aspects, process 1100 includes transmitting, to a network entity, signaling indicating the one or more parameters, and receiving, from the network entity, the selective relaying configuration based at least in part on the signaling, wherein the selective relaying configuration is based at least in part on at least one of the one or more parameters of the relay node, a parameter of the source node, or a parameter of a destination node of the one or more destination nodes.

In a seventeenth aspect, alone or in combination with one or more of the first through sixteenth aspects, the transmission includes an indication of a remote user equipment destination identifier.

In an eighteenth aspect, alone or in combination with one or more of the first through seventeenth aspects, the relaying configuration is received via at least one of a header of a data protocol data unit (PDU), a control PDU, medium access signaling, sidelink control information, or controlling signaling.

In a nineteenth aspect, alone or in combination with one or more of the first through eighteenth aspects, the relaying configuration indicates at least one of whether the relaying configuration is associated with the relaying multi-node communication mode, a source address, a destination address, or one or more identifiers of the relay node.

In a twentieth aspect, alone or in combination with one or more of the first through nineteenth aspects, process 1100 includes transmitting a discovery message indicating a set of group identifiers for which groupcast relaying is supported.

In a twenty-first aspect, alone or in combination with one or more of the first through twentieth aspects, the set of group identifiers are associated with the one or more destination nodes based at least in part on the one or more destination nodes being in range of the relay node.

In a twenty-second aspect, alone or in combination with one or more of the first through twenty-first aspects, the transmission is a broadcast transmission that does not utilize feedback.

In a twenty-third aspect, alone or in combination with one or more of the first through twenty-second aspects, the transmission is a groupcast transmission that utilizes feedback.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a source node (e.g., UE 120, UE 305, UE 405, UE 410, one or more of the UEs of FIG. 5, the source UE of FIG. 6, the source UE of FIG. 7, the source UE of FIG. 8, or the source UE of FIG. 9), or a source node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a discovery component 1208, among other examples.

In some aspects, the apparatus 1200 may be configured to perform one or more operations described herein in connection with FIGS. 3-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the source node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the source node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the source node described in connection with FIG. 2. In some aspects, the transmission component 1204 may be co-located with the reception component 1202 in a transceiver.

The discovery component 1208 may discover one or more relay nodes. The transmission component 1204 may transmit, to the one or more relay nodes, an indication of a relaying configuration associated with a selected multi-node communication mode, of a relaying multi-node communication mode and a non-relaying multi-node communication mode. The transmission component 1204 may transmit a transmission to the one or more relay nodes based at least in part on the selected multi-node communication mode or the relaying configuration.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a relay node (e.g., UE 120, UE 305, UE 405, UE 410, one or more of the UEs of FIG. 5, the relay UE of FIG. 6, the relay UE of FIG. 7, the relay UE of FIG. 8, or the relay UE of FIG. 9), or a relay node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include a discovery component 1308, among other examples.

In some aspects, the apparatus 1300 may be configured to perform one or more operations described herein in connection with FIGS. 3-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the relay node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the relay node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the relay node described in connection with FIG. 2. In some aspects, the transmission component 1304 may be co-located with the reception component 1302 in a transceiver.

The discovery component 1308 may discover a source node and one or more destination nodes. The reception component 1302 may receive an indication of a relaying configuration associated with a relaying multi-node communication mode. The reception component 1302 may receive a transmission from the source node. The transmission component 1304 may relay the transmission to the one or more destination nodes based at least in part on the relaying configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a source node, comprising: discovering one or more relay nodes; transmitting, to the one or more relay nodes, an indication of a relaying configuration associated with a selected multi-node communication mode, of a relaying multi-node communication mode and a non-relaying multi-node communication mode; and transmitting a transmission to the one or more relay nodes based at least in part on the selected multi-node communication mode or the relaying configuration.
Aspect 2: The method of Aspect 1, further comprising: selecting the selected multi-node communication mode for the transmission.
Aspect 3: The method of any of Aspects 1-2, wherein discovering the one or more relay nodes is based at least in part on a location identifier indicated in one or more discovery messages associated with the one or more relay nodes.
Aspect 4: The method of any of Aspects 1-3, wherein discovering the one or more relay nodes further comprises: receiving an indication of one or more reachable remote nodes associated with a relay node of the one or more relay nodes.
Aspect 5: The method of Aspect 4, wherein the indication of the one or more reachable remote nodes is based at least in part on one or more location identifiers associated with the one or more reachable remote nodes.
Aspect 6: The method of any of Aspects 1-5, wherein discovering the one or more relay nodes further comprises: receiving an indication of whether the one or more relay nodes support unicast relaying, groupcast relaying, broadcast relaying, both unicast relaying and groupcast relaying, or all of unicast relaying, groupcast relaying, and broadcast relaying as the selected multi-node communication mode.
Aspect 7: The method of any of Aspects 1-6, wherein the selected multi-node communication mode is the relaying multi-node communication mode, and wherein transmitting the transmission to the one or more relay nodes further comprises: transmitting the transmission to a destination identifier, a Layer 3 identifier, or a Layer 2 identifier, associated with a group of nodes.
Aspect 8: The method of Aspect 7, wherein the destination identifier is associated with a group identifier corresponding to the group of nodes including the one or more relay nodes.
Aspect 9: The method of Aspect 7, wherein the destination identifier indicates to relay if the transmission is a groupcast transmission.
Aspect 10: The method of any of Aspects 1-9, wherein the selected multi-node communication mode includes the relaying multi-node communication mode, and wherein a header of the transmission indicates that the transmission is associated with the relaying multi-node communication mode.
Aspect 11: The method of Aspect 10, wherein the header includes a sequence number associated with duplicate handling.
Aspect 12: The method of any of Aspects 1-11, wherein the transmission includes an indication for the one or more relay nodes to relay the transmission.
Aspect 13: The method of Aspect 12, further comprising: selecting the one or more relay nodes to relay the transmission.
Aspect 14: The method of Aspect 12, wherein selecting the one or more relay nodes is based at least in part on at least one of: a link quality associated with the one or more relay nodes, whether the one or more relay nodes support relaying for a group identifier, one or more locations associated with the one or more relay nodes, a loading or power metric of the one or more relay nodes, or a number of nodes reachable by the one or more relay nodes or within a threshold range of the one or more relay nodes.
Aspect 15: The method of Aspect 12, wherein selecting the one or more relay nodes is based at least in part on discovering the one or more relay nodes.
Aspect 16: The method of any of Aspects 1-15, wherein the transmission includes an indication of a group identifier corresponding to a group of destination nodes for the selected multi-node communication mode.
Aspect 17: The method of any of Aspects 1-16, further comprising selecting both of the relaying multi-node communication mode and the non-relaying multi-node communication mode, wherein transmitting the transmission to the one or more relay nodes based at least in part on the selected multi-node communication mode further comprises transmitting the transmission using the relaying multi-node communication mode and the non-relaying multi-node communication mode.
Aspect 18: The method of any of Aspects 1-17, further comprising selecting the multi-node communication mode based at least in part on a number of received acknowledgments or a number of retransmissions.
Aspect 19: The method of any of Aspects 1-18, wherein the relaying configuration includes a selective relaying configuration of the transmission.
Aspect 20: The method of Aspect 19, wherein the configuration is based at least in part on one or more parameters including at least one of: a link quality associated with the one or more relay nodes, whether the one or more relay nodes support relaying for a group identifier, a location associated with the one or more relay nodes, a loading or power metric of the one or more relay nodes, or a number of nodes reachable by the one or more relay nodes or within a threshold range of the one or more relay nodes.
Aspect 21: The method of Aspect 19, wherein the relaying configuration is transmitted via at least one of: a header of a data protocol data unit (PDU), a control PDU, medium access signaling, sidelink control information, or control signaling.
Aspect 22: The method of Aspect 19, wherein the relaying configuration indicates at least one of: whether the relaying configuration is associated with the relaying multi-node communication mode, a source address, a destination identifier corresponding to a group identifier, the group identifier, or one or more identifiers of the one or more relay nodes.
Aspect 23: The method of any of Aspects 1-22, wherein a discovery message received from the one or more relay nodes indicates a set of group identifiers for which groupcast relaying is supported.
Aspect 24: The method of Aspect 23, wherein the set of group identifiers are associated with one or more destination nodes that are in range of the one or more relay nodes.
Aspect 25: The method of any of Aspects 1-24, wherein the transmission is a broadcast transmission that does not utilize feedback and the selected multi-node communication mode is a broadcast communication mode.
Aspect 26: The method of any of Aspects 1-24, wherein the transmission is a groupcast transmission that utilizes feedback and the selected multi-node communication mode is a groupcast communication mode.
Aspect 27: A method of wireless communication performed by a relay node, comprising: discovering a source node and one or more destination nodes; receiving an indication of a relaying configuration associated with a relaying multi-node communication mode; receiving a transmission from the source node; and relaying the transmission to the one or more destination nodes based at least in part on the relaying configuration.
Aspect 28: The method of Aspect 27, wherein the indication is received from the source node.
Aspect 29: The method of any of Aspects 27-28, wherein discovering the source node and the one or more destination nodes is based at least in part on a location identifier indicated in one or more discovery messages received by the relay node.
Aspect 30: The method of any of Aspects 27-29, further comprising: transmitting a discovery message including an indication of one or more reachable remote nodes associated with the relay node.
Aspect 31: The method of Aspect 30, wherein the indication of the one or more reachable remote nodes is based at least in part on one or more location identifiers associated with the one or more reachable remote nodes.
Aspect 32: The method of any of Aspects 27-31, further comprising: transmitting an indication of whether the relay node supports unicast relaying, groupcast relaying, or both unicast relaying and groupcast relaying as the selected multi-node communication mode.
Aspect 33: The method of any of Aspects 27-32, wherein the transmission is directed to a destination identifier associated with a group of relay nodes including the relay node.
Aspect 34: The method of Aspect 33, wherein the destination identifier is associated with a group identifier corresponding to the group of relay nodes including the relay node.
Aspect 35: The method of Aspect 33, wherein the destination identifier indicates to relay if the transmission is a groupcast transmission.
Aspect 36: The method of any of Aspects 27-35, wherein a header of the transmission indicates that the transmission is associated with the relaying multi-node communication mode.
Aspect 37: The method of Aspect 36, wherein the header includes a sequence number associated with duplicate handling.
Aspect 38: The method of any of Aspects 27-37, wherein the transmission includes an indication for the relay node to relay the transmission.
Aspect 39: The method of any of Aspects 27-38, further comprising: determining whether to relay the transmission.
Aspect 40: The method of Aspect 39, wherein determining whether to relay the transmission is based at least in part on a configuration based at least in part on one or more parameters of the relay node including at least one of: a link quality associated with the relay node, whether the relay node supports relaying for a group identifier, one or more locations associated with the relay node, the source node, or the one or more destination nodes, a loading or power metric of the relay node, or a number of destination nodes reachable by the relay node or within a threshold range of the relay node.
Aspect 41: The method of Aspect 40, wherein the configuration is received in the relaying configuration.
Aspect 42: The method of Aspect 40, further comprising: receiving signaling indicating the one or more parameters; and determining the configuration based at least in part on at least one of the signaling or a metric determined by the relay node.
Aspect 43: The method of Aspect 40, further comprising: transmitting, to a network entity, signaling indicating the one or more parameters; and receiving, from the network entity, the configuration based at least in part on the signaling, wherein the configuration is based at least in part on at least one of: the one or more parameters of the relay node, a parameter of the source node, or a parameter of a destination node of the one or more destination nodes.
Aspect 44: The method of any of Aspects 27-43, wherein the transmission includes an indication of a remote user equipment destination identifier.
Aspect 45: The method of any of Aspects 27-44, wherein the relaying configuration is received via at least one of: a header of a data protocol data unit (PDU), a control PDU, medium access signaling, sidelink control information, or control signaling.
Aspect 46: The method of Aspect 45, wherein the relaying configuration indicates at least one of: whether the relaying configuration is associated with the relaying multi-node communication mode, a source address, a destination address, or one or more identifiers of the relay node.
Aspect 47: The method of any of Aspects 27-46, further comprising: transmitting a discovery message indicating a set of group identifiers for which groupcast relaying is supported.
Aspect 48: The method of Aspect 47, wherein the set of group identifiers are associated with the one or more destination nodes based at least in part on the one or more destination nodes being in range of the relay node.
Aspect 49: The method of any of Aspects 27-48, wherein the transmission is a broadcast transmission that does not utilize feedback.
Aspect 50: The method of any of Aspects 27-48, wherein the transmission is a groupcast transmission that utilizes feedback.
Aspect 51: An apparatus for wireless communication at a device, comprising a processor; memory coupled with the processor; and instructions stored in the memory and executable by the processor to cause the apparatus to perform the method of one or more of Aspects 1-50.
Aspect 52: A device for wireless communication, comprising a memory and one or more processors coupled to the memory, the one or more processors configured to perform the method of one or more of Aspects 1-50.
Aspect 53: An apparatus for wireless communication, comprising at least one means for performing the method of one or more of Aspects 1-50.
Aspect 54: A non-transitory computer-readable medium storing code for wireless communication, the code comprising instructions executable by a processor to perform the method of one or more of Aspects 1-50.
Aspect 55: A non-transitory computer-readable medium storing a set of instructions for wireless communication, the set of instructions comprising one or more instructions that, when executed by one or more processors of a device, cause the device to perform the method of one or more of Aspects 1-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A source node for wireless communication, comprising:
a memory; and
one or more processors, coupled to the memory, configured to:
discover one or more relay nodes;
transmit a relaying configuration or an indication associated with the relaying configuration, wherein the relaying configuration is associated with a selected multi-node communication mode including at least one of a relaying multi-node communication mode or a non-relaying multi-node communication mode; and
transmit a transmission to the one or more relay nodes based at least in part on the selected multi-node communication mode.

2. The source node of claim 1, wherein discovering the one or more relay nodes is based at least in part on a location identifier indicated in one or more discovery messages associated with the one or more relay nodes.

3. The source node of claim 1, wherein the one or more processors, to discover the one or more relay nodes, are configured to:
receive an indication of one or more reachable remote nodes associated with a relay node of the one or more relay nodes.

4. The source node of claim 1, wherein the one or more processors, to discover the one or more relay nodes, are configured to:
receive a relaying support indication of whether the one or more relay nodes support unicast relaying, groupcast relaying, broadcast relaying, both unicast relaying and groupcast relaying, or all of unicast relaying, groupcast relaying, and broadcast relaying, wherein the selected multi-node communication mode is based at least in part on the relaying support indication.

5. The source node of claim 1, wherein the selected multi-node communication mode is the relaying multi-node communication mode, and wherein transmitting the transmission to the one or more relay nodes further comprises:
transmit the transmission to a destination identifier, a Layer 3 identifier, or a Layer 2 identifier, associated with a group of nodes.

6. The source node of claim 5, wherein the destination identifier is associated with a group identifier corresponding to the group of nodes including the one or more relay nodes.

7. The source node of claim 5, wherein the selected multi-node communication mode includes the relaying multi-node communication mode, and wherein a header of the transmission indicates that the transmission is associated with the relaying multi-node communication mode.

8. The source node of claim 1, wherein the transmission includes the indication in a header associated with the transmission.

9. The source node of claim 1, wherein the one or more processors are further configured to:
select the one or more relay nodes to relay the transmission.

10. The source node of claim 1, wherein the transmission includes an indication of a group identifier corresponding to a group of destination nodes for the selected multi-node communication mode.

11. The source node of claim 1, wherein the one or more processors are further configured to select both of the relaying multi-node communication mode and the non-relaying multi-node communication mode, wherein, to transmit the transmission to the one or more relay nodes based at least in part on the selected multi-node communication mode, the one or more processors are further configured to transmit the transmission using the relaying multi-node communication mode and the non-relaying multi-node communication mode.

12. The source node of claim 1, wherein the one or more processors are further configured to select the multi-node communication mode based at least in part on a number of received acknowledgments or a number of retransmissions.

13. The source node of claim 1, wherein the relaying configuration includes a selective relaying configuration that indicates one or more parameters associated with determining whether the transmission is to be relayed.

14. The source node of claim 13, wherein the one or more parameters include at least one of:
a link quality associated with the one or more relay nodes,
whether the one or more relay nodes support relaying for a group identifier,
a location associated with the one or more relay nodes,
a loading or power metric of the one or more relay nodes, or
a number of nodes reachable by the one or more relay nodes or within a threshold range of the one or more relay nodes.

15. The source node of claim 13, wherein the relaying configuration indicates a set of parameters of a multi-node communication relaying table including at least one of:
whether the relaying configuration is associated with the relaying multi-node communication mode,
a source address,
a destination identifier corresponding to a group identifier,
the group identifier, or
one or more identifiers of the one or more relay nodes.

16. The source node of claim 15, wherein the multi-node communication relaying table includes the selective relaying configuration.

17. The source node of claim 1, wherein a discovery message from the one or more relay nodes indicates a set of group identifiers for which groupcast relaying is supported.

18. The source node of claim 1, wherein the transmission is a broadcast transmission that does not utilize feedback and the selected multi-node communication mode is a broadcast communication mode.

19. The source node of claim 1, wherein the transmission is a groupcast transmission that utilizes feedback and the selected multi-node communication mode is a groupcast communication mode.

20. A relay node for wireless communication, comprising:
a memory; and
one or more processors, coupled to the memory, configured to:
discover a source node and one or more destination nodes;
receive a relaying configuration or an indication associated with the relaying configuration associated with a relaying multi-node communication mode;
receive a transmission from the source node; and
relay the transmission to the one or more destination nodes based at least in part on the relaying configuration.

21. The relay node of claim 20, wherein the one or more processors are further configured to:
transmit a discovery message including an indication of one or more reachable remote nodes associated with the relay node.

22. The relay node of claim 20, wherein the one or more processors are further configured to:
transmit a relaying support indication of whether the relay node supports unicast relaying, groupcast relaying, broadcast relaying, both unicast relaying and groupcast relaying, or all of unicast relaying, groupcast relaying, and broadcast relaying.

23. The relay node of claim 20, wherein the transmission is directed to a destination identifier associated with a group of relay nodes including the relay node.

24. The relay node of claim 20, wherein the one or more processors are further configured to:
determine whether to relay the transmission.

25. The relay node of claim 24, wherein the one or more processors, to determine whether to relay the transmission, are configured to determine whether to relay the transmission based at least in part on a selective relaying configuration, wherein the selective relaying configuration is based at least in part on one or more parameters including at least one of:
a link quality associated with the relay node,
whether the relay node supports relaying for a group identifier,
one or more locations associated with the relay node, the source node, or the one or more destination nodes,
a loading or power metric of the relay node, or
a number of destination nodes reachable by the relay node or within a threshold range of the relay node.

26. The relay node of claim 25, wherein the one or more processors are further configured to:
transmit, to a network entity, signaling indicating the one or more parameters; and
receive, from the network entity, the selective relaying configuration based at least in part on the signaling, wherein the selective relaying configuration is based at least in part on at least one of:
the one or more parameters of the relay node,
a parameter of the source node, or
a parameter of a destination node of the one or more destination nodes.

27. A method of wireless communication performed by a source node, comprising:
discovering one or more relay nodes;
transmitting a relaying configuration or an indication associated with the relaying configuration, wherein the relaying configuration is associated with a selected multi-node communication mode including at least one of a relaying multi-node communication mode or a non-relaying multi-node communication mode; and
transmitting a transmission to the one or more relay nodes based at least in part on the selected multi-node communication mode.

28. The method of claim 27, wherein the relaying configuration includes a selective relaying configuration that indicates one or more parameters associated with determining whether the transmission is to be relayed.

29. A method of wireless communication performed by a relay node, comprising:
discovering a source node and one or more destination nodes;
receiving a relaying configuration or an indication associated with the relaying configuration associated with a relaying multi-node communication mode;
receiving a transmission from the source node; and
relaying the transmission to the one or more destination nodes based at least in part on the relaying configuration.

30. The method of claim 29, further comprising:
determining whether to relay the transmission based at least in part on a selective relaying configuration.
